(19) United States
(12) Patent Application Publication
(10) Pub. No.: US 2002/0129178 A1
(43) Pub. Date: Sep. 12, 2002

(54) State pattern enhancement

(75) Inventors: Anthony W. Steere JR., Boulder, CO (US); Michael Nunez, Lyons, CO (US); William C. Ankeny, Westminster, CO (US); Thomas Joseph Zezula, Highlands Ranch, CO (US); John L. Joyce, Arvada, CO (US); Michael Francis Schweitzer, Erie, CO (US)

Correspondence Address: Wayne P. Bailey, Storage Technology Corporation, One Storage Tek Drive, Louisville, CO, 80028-4309, US

(73) Assignee: Storage Technology Corporation

(21) Appl. No.: 09/801,020

(22) Filed: Mar. 8, 2001

(51) Int. Cl. G06F 9/44

(52) U.S. Cl. 709/315

(57) ABSTRACT

A method for enhancing state patterns in object-oriented programming is provided. The method comprises combining state patterns with hierarchical finite state machines that have history mechanisms. Inheritance, polymorphism and reflection are used to create state objects and call methods associated with those objects, which execute event entry and event exit behavior. The present invention distinguishes between internal and external state transitions and allows users of the pattern to clearly define execution of entry and exit behavior by calculating class hierarchies in which parent classes define common behavior in child classes. The present invention more accurately represents the complexity of state machines reified as software objects.

1. FIELD OF THE INVENTION

The present invention relates to object-oriented computer programming.

2. BACKGROUND OF THE INVENTION

Object-oriented programming is an evolutionary form of modular programming with more formal rules that allow pieces of software to be reused and interchanged between programs. An object is a self-contained module of data and its associated processing. Objects are the software building blocks of object technology. In object technology, a class is a user-defined data type that defines a collection of data and methods (or functions) that are associated with that data type. An object is one instance of the class. An instance is a member of a class; for example, “Lassie” is an instance of the class “dog.” When an instance is created, the initial values of its instance data or variables are assigned. A constructor is an operation that constructs an instance of a class, allocates memory to dynamic objects, creates the binding of messages to operations, and initializes the values of the properties.

Inheritance refers to the definition of a derived class in terms of one or more base classes, such as the relationship between parent and child classes. Encapsulation involves the hiding of data inside an object so that the data are only accessible through messages to the object. Reflection can be used to examine an object to find out what classes it extends and what methods and variables it has and to call these methods. Polymorphism is the ability of a single name to refer to different things having different forms.

In object-oriented programming, design patterns are used to describe a problem, a solution to the problem consisting of an arrangement of objects and classes, and the consequences of applying the solution. The basic concept of a pattern is adding a layer of abstraction, which involves isolating changes in the code. When a part of a program is likely to change for one reason or another, design patterns are used to prevent those changes from propagating other changes throughout the code.

Design patterns can be classified under several purposes. Creational patterns describe how an object is created and involves isolating the details of object creation. In this manner, the code is not dependent on what types of objects there are and thus does not have to be changed when a new object type is added. Structural patterns are used to design objects to satisfy particular constraints. This involves working with the manner in which objects are connected to ensure that changes in the system do not require changes to the connections. Behavioral patterns handle particular types of actions within a program and encapsulate functionality that need to be performed, such as interpreting a language or implementing an algorithm.

The State pattern is a type of behavioral pattern. A state is any status, situation, or mode of an object during which certain rules of overall behavior apply. It is known in the art that the State pattern may be used to eliminate the need for case statements based on state, as well as the need for most state-based preconditions (assertions on an operation that must evaluate to true prior to execution) and postconditions (assertions on an operation that must be true immediately after execution if all preconditions were true prior to execution). State patterns are described in Design Patterns: Elements of Reusable Object-Oriented Software by Gamma et al. (Addison-Wesley Publishing Co. 1994; ISBN 0-201-63361-2), pp. 305-313.

State machine infrastructure is used to encapsulate the mechanism for processing events and changing states, and recording the current substate upon leaving a parent state, if necessary. In this way, objects and operations are defined such that their implementation details are hidden behind an abstract interface. State machine notation designates the valid state and transitions that are allowed, and the state machine infrastructure determines how to make that transition.

State transitions can be external or internal. An external state transition comprises a change from one state (or substate) to another. External state transitions may involve special helper methods, such as entry and exit behavior. An entry behavior (e:) is a specific function that is performed upon entering a state, and an exit behavior (x:) is performed upon leaving a state. A state transition simply defines a method whose name matches the event.

A history mechanism (H:) can be used as a type of bookmark for when a state machine leaves a state, thus allowing the machine to pick up where it left off should the machine return to the same parent state. History mechanisms are described in Real-Time Object-Oriented Modeling by Bran Selic et al. (John Wiley & Sons, Inc. 1994; ISBN 0-471-59917-4), pp. 302-359.

Hierarchical features can be added to state machines. Hierarchy allows the generalization and specialization of states, in which data and behavior in common between states is placed at some common parent class and then may be shared by some child classes.

The State pattern used in prior art has several limitations. For one, most state machines do not have the same events for each state, the State pattern show that all classes have the same methods. Additionally, it is difficult to determine if entry or exit behavior should be executed for a state given common class hierarchies. If entry or exit behavior is defined for the parent state, transitions between sub-states should not execute the entry or exit behavior. In contrast, if the transition is into or out of the parent state the entry and exit behavior should be executed. Certain hierarchical states require that upon reentry to the parent state the sub-state actually entered was the previous sub-state. However, the current State pattern does not have a history mechanism.

Therefore, it would be desirable to have a state pattern that is more versitile than the current approach and allows proper execution of entry and exit behaviors, while ensuring that a parent state with history will return to a previous substate upon entry.

### SUMMARY OF THE INVENTION

The present invention provides a method for enhancing state patterns in object-oriented programming. The method comprises combining state patterns with hierarchical finite state machines that have history mechanisms. Inheritance, polymorphism and reflection are used to create state objects and call methods associated with those objects, which execute event entry and event exit behavior. The present invention distinguishes between internal and external state transitions and allows users of the pattern to clearly define execution of entry and exit behavior by evaluating class hierarchies in which parent classes define common behavior in child classes. The present invention more accurately represents the complexity of state machines reified as software objects.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram illustrating a data processing system in which the present invention may be implemented;

FIG. 2 depicts a state diagram illustrating state machine notation;

FIG. 3A depicts a state diagram illustrating hierarchical state machine notation;

FIG. 3B depicts the state diagram in FIG. 3A, with the addition of a history mechanism;

FIG. 4 depicts an object diagram illustrating a state machine class hierarchy; and

FIG. 5 depicts an object diagram illustrating a history mechanism.

### DETAILED DESCRIPTION OF THE PREFERRED EMBODIMENT

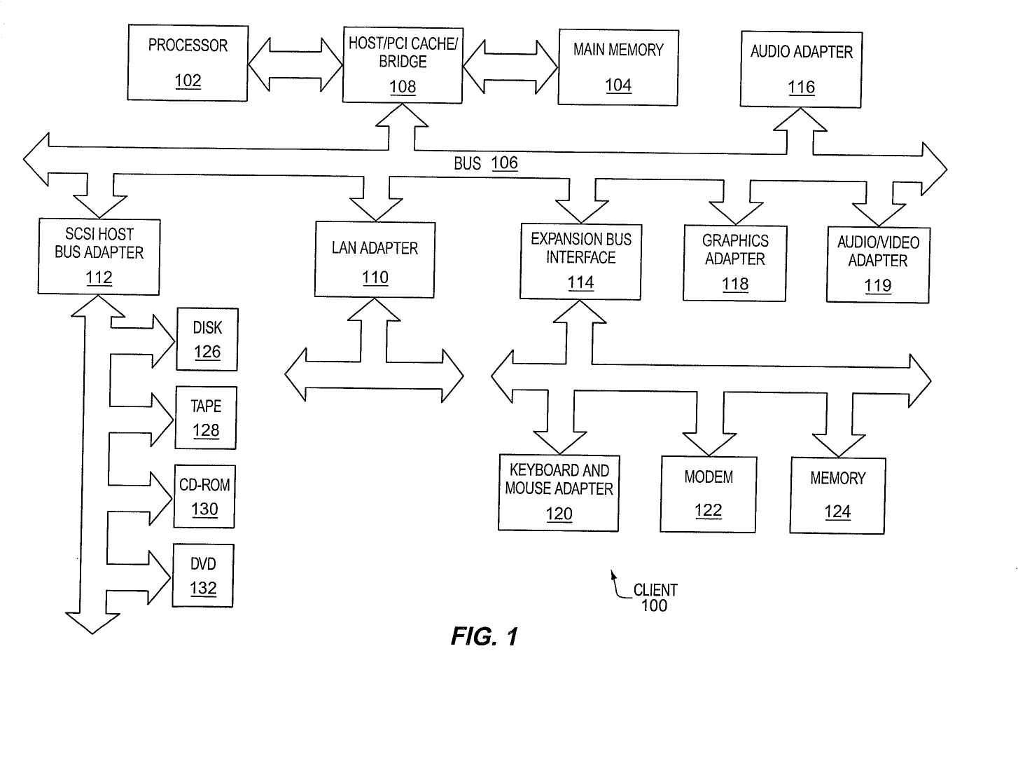

The present invention may be employed in any computing environment in which object-oriented programming is used. Such computing environments are diverse and may range from PCs and computer networks to oil drilling and space exploration devices to hand held computing devices and appliances. Furthermore, the present invention may be employed in software or hardwired into a integrated circuit (IC) chip. With reference now to the figures, FIG. 1, a block diagram illustrating a data processing system is depicted in which the present invention may be implemented. Data processing system 100 is merely an example of one type of device in which the present invention may be incorporated. However, those skilled in the art will appreciate that the present invention may be implemented in many other types of devices as well as discussed previously. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 are connected to PCI local bus 106 through PCI bridge 108. PCI bridge 108 also may include an integrated memory controller and cache memory for processor 102. Additional connections to PCI local bus 106 may be made through direct component interconnection or through add-in boards. In the depicted example, local area network (LAN) adapter 110, SCSI host bus adapter 112, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. Small computer system interface (SCSI) host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system, such as Windows 2000, which is available from Microsoft Corporation. An object oriented programming system such as Java may run in conjunction with the operating system and provide calls to the operating system from Java programs or applications executing on data processing system 100. “Java” is a trademark of Sun Microsystems, Inc. Instructions for the operating system, the object-oriented operating system, and applications or programs are located on storage devices, such as hard disk drive 126, and may be loaded into main memory 104 for execution by processor 102. Those of ordinary skill in the art will appreciate that the hardware in FIG. 1 may vary depending on the implementation. Other internal hardware or peripheral devices, such as flash ROM (or equivalent nonvolatile memory) or optical disk drives and the like, may be used in addition to or in place of the hardware depicted in FIG. 1. Also, the processes of the present invention may be applied to a multiprocessor data processing system.

As another example, data processing system 100 may be a stand-alone system configured to be bootable without relying on some type of network communication interface, whether or not data processing system 100 comprises some type of network communication interface. As a further example, data processing system 100 may be a Personal Digital Assistant (PDA) device, which is configured with ROM and/or flash ROM in order to provide non-volatile memory for storing operating system files and/or user-generated data.

The depicted example in FIG. 1 and above-described examples are not meant to imply architectural limitations. For example, data processing system 100 also may be a notebook computer or hand held computer in addition to taking the form of a PDA. Data processing system 100 also may be a kiosk or a Web appliance.

The present invention overcomes the limitation of the prior art by combining state patterns with hierarchical finite state machines and inheritance, polymorphism and reflection. The state machines are used to encapsulate the behavior of the states and record the history upon leaving the parent state. Inheritance, polymorphism and reflection are used to create states and to call the methods which execute the behavior appropriate to an event, entry to the state, or exit from the state. With the present approach entry and exit behavior for internal state transitions, versus external state transitions, are cleanly described, and a history mechanism can easily be implemented. The present invention makes it easier to go from the state machine to the code and back.

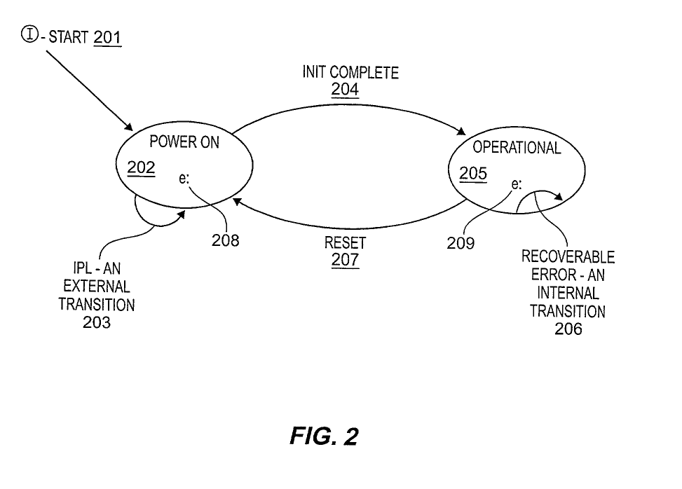

Referring now to FIG. 2, a state diagram illustrating state machine notation is depicted. Events are transitions that are mapped to methods or functions. In contrast to external state transitions, internal state transitions do not tell the state machine infrastructure to change the state.

For the present diagram, the following events occur: The state machine starts at the “I” state 201 and transitions to Power On 202. At Power On 202, an external self-transition 203 called initial program load (IPL) is performed and the power on entry method 208 is executed.

From here, an Init Complete event 204 performs a transition to the Operational state 205. Again, an entry 209 is performed upon transition to the Operational state 205. The present example illustrates a Recoverable Error 206 occurring in the Operational state, which is an internal self-transition defined for the Operational state 205. Because the Recoverable Error 206 is internal, it does not call the change state functionality in the state machine infrastructure. Therefore, the entry method 209 for the Operational state 205 is not executed. The enhancements to the state pattern do not prevent these self-transitions. Upon return to the Power On state 202 by a Reset event 207, the entry method 208 for Power On is executed.

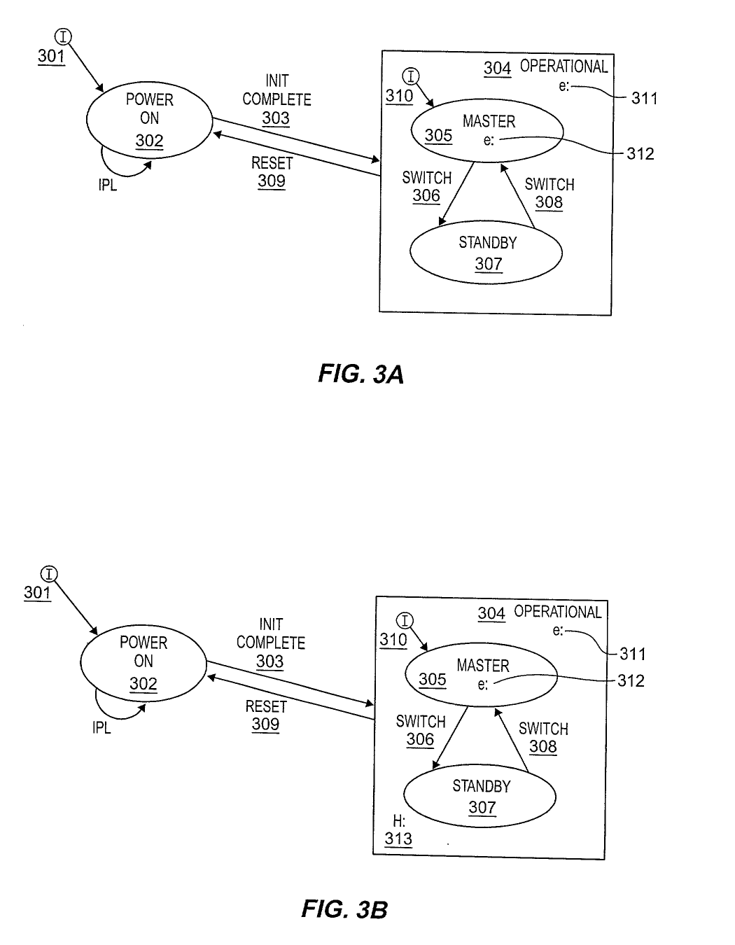

Turning now to FIG. 3A, a state diagram illustrating hierarchical state machine notation is depicted. For the present diagram, the following events occur: Upon startup, the state machine moves from an initial state 301 to Power On 302. From here, the Init Complete event 303 is received, and the state machine transitions to the Operational parent state 304. Upon transitioning to the Operational parent state 304 the Operational entry method 311 is executed. After the Operational entry method 311 is called, the state machine transitions to Master state 310 and master entry method e: 312 is called. The I 310 is inserted into the design to tell the state machine to always transition to the Master substate 305 upon entry to the Operational Parent state 304.

Calling the parent entry method 311 from within the child entry method 312 is known as an overloaded method invocation. Optionally, the Master entry method 312 may execute without calling the parent entry method 311, which is known as override. A Switch event 306 then causes the state machine to transition from Master 305 to the Standby state 307, which does not have its own defined entry method. Object Oriented Languages state that a parent's method is called if the child does not define one. The child inherits the parent's behavior. This means that the Operational entry method 311 is called on the Switch transition 306 into standby state 307. Herein lies a problem with the prior art.

The state machine should execute the entry method 311 for Operational state 304 when going from Power On 302 to the Master substate 305, because the State machine is entering the Operational state 304. Similarly, if a history mechanism is employed (discussed below), the entry method 311 should be executed when going from Power On 302 to Standby 307. In contrast, the Operational entry method 311 should not be executed when going from the Master 305 to Standby 307 on the Switch event 306, because the system is not entering the Operational state 304 but staying within Operational state 304. However, in the prior art, because Standby 307 does not have its own defined entry method, the state machine will execute the Operational entry 311. The question is how to prevent the state machine from executing the Operational entry method 311 when transitioning from Master 305 to Standby 307. The solution is to use the information already imbedded in the class hierarchies.

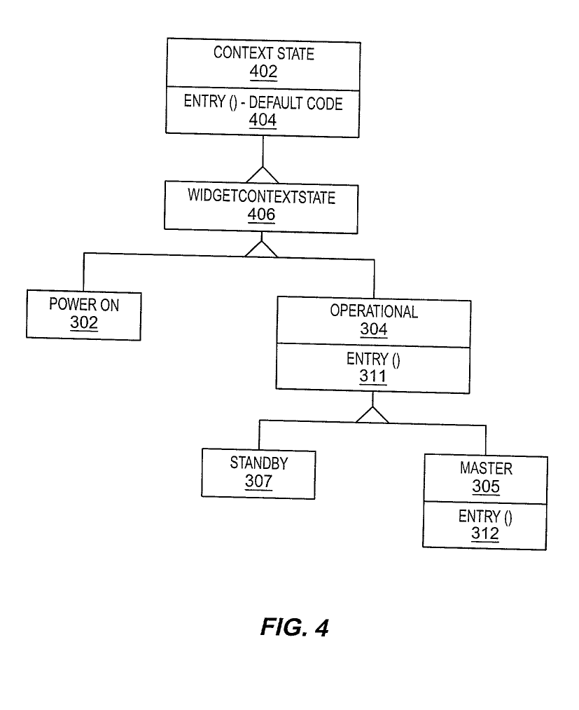

Referring to FIG. 4, an object diagram illustrating a state machine class hierarchy based on FIG. 3A is depicted. To solve the problem of when to execute entry behavior, a list of classes in the inheritance hierarchy is created for the current state and the next state. For example, the list for Standby 307 is: ContextState 402, WidgetContextState 406, Operational 304, and Standby 307. The list for Master 305 is ContextState 402, WidgetContextState 406, Operational 304, and Master 305. The two lists can be compared to determine the common parent 304. The Java Reflection package (or the equivalent for other object-oriented languages) enables the code to determine which class defines the entry method that would be called. For example, Master state 305 defines the entry method 312 that would be called. For Standby state 307, Operational state 304 defines the entry method 311 that would be called.

A method is executed if it is defined in a class below the common parent class. If a method is defined at the common parent level or above, the method is not executed. For example, in transition 308, Master 305 would execute its entry method 311 because that entry method 311 is defined below the common parent class Operational 304. However, for transition 306, Standby 307 does not have a defined entry method. The entry method defined for Standby is entry method 311, which is defined at the common parent level, Operational 304. In this case, the state machine does not execute an entry method when transitioning to Standby 307. As a further example, if the entry method 311 was defined at the WidgetContextState level 406 (instead of Operational 304), the state machine would not execute the entry 311 when transitioning to Standby because the entry 311 is defined above the common parent class, Operational 304.

An optional exception to the above rule is if the method is defined at the level of the base class, which in FIG. 4 is ContextState 402. In such a case the method is always called. For example, this rule could be employed to facilitate common behavior for all states that do not have an entry method defined. In order to coordinate the activity of different state machines and components, event responses are sent when an event is complete. Event responses are needed for states not defining an entry method. Therefore, ensuring that the methods defined in the base class 402 is always called helps the state machine infrastructure coordinate different state machines. This rule simplifies the code by generalizing the behavior to the common denominator.

Referring back to FIG. 3A, a Reset event 309 causes the state machine to transition from Standby 307 back to Power On 302. If an Init Complete event 303 causes the state machine to transition back to the Operational state 304, the machine will repeat the same sequence described above: execute entry 311, transition to Master 305 (due to I 310) and execute entry 312. Another switch event is needed to transition to standby 307. However, if a history mechanism is added to the state machine, the sequence upon returning to Operational 304 is different.

Referring to FIG. 3B, the state diagram in FIG. 3A is illustrated with the addition of a history mechanism in accordance with the present invention. The history mechanism 313 records the current state when the state machine transitions out of Operational 304. For example, if the current state is Standby 307, the history mechanism 313 will record this when the state machine transitions out of Operational 304 back to Power On 302. Upon transition from Power On 302 back to Operational 304. Because the history mechanism 313 is set to Standby 307, the state machine will ignore the instructions from I 310. Instead of transitioning back to Master state 305 and executing entry method 312, the state machine transitions directly back to Standby 307 and executes Operational entry method 311.

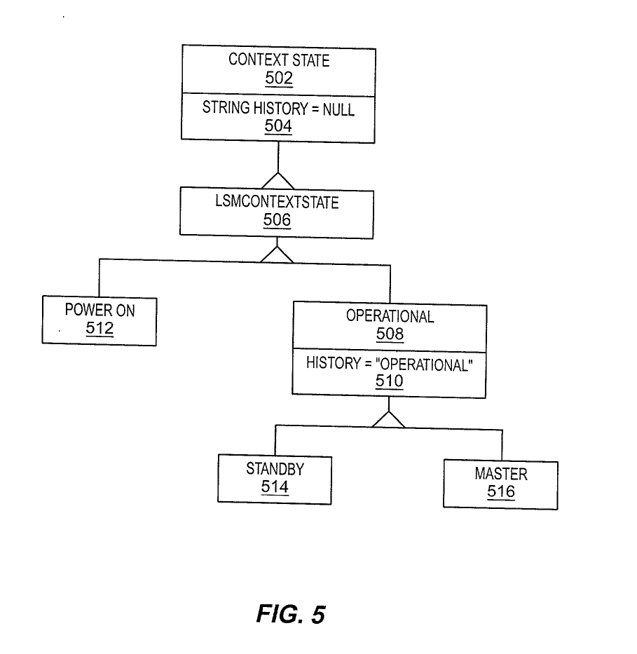

Referring now to FIG. 5, an object diagram illustrating a history mechanism is depicted in accordance with the present invention. The base class ContextState 502 defines a field 504 called “history”, which is initialized to null. In the present example, state 508 has a history mechanism and states 502, 506, 512, 514 and 516 do not have a history mechanism. States 514 and 516 do not have their own history mechanisms but are controlled by the Operational history mechanism 510. State 508 sets the history field in its constructor 510 to the name of its class.

The state machine infrastructure checks if the history field is defined when exiting a class. If the history field is defined anywhere in the hierarchy, then the state is saved. An event that causes a transition back into the state machine does not specify a substate. Instead it specifies the parent state. Upon changing to a new state, the state machine infrastructure checks to see if the new state matches the name of the state that was stored in the history field. If there is a match, the saved state becomes the current state. Otherwise a new state is created.

It should be pointed out that the examples illustrated in the above-referenced Figures do not depict exit methods (x:) for the states, only entry methods (e:). However, any of the states illustrated in the Figures could have defined exit methods in addition to, or instead of, entry methods. Such exit methods would essentially constitute a “house cleaning” function to acknowledge all pending transactions before leaving a state. The present invention also applies to other methods defined in a class hierarchy, not just entry and exit methods.

Existing or new products in an object-oriented language which use state machines can use the enhanced state pattern to more accurately translate their diagrams to code. If the products use the Java language, then they can reuse the state machine infrastructure saving development and test time.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for enhancing state patterns in object-oriented programming, comprising:
combining state patterns with hierarchical finite state machines; and
using inheritance, polymorphism and reflection to create hierarchical state objects and call methods associated with the state objects.

2. The method according to claim 1, wherein the methods called by reflection execute behaviors comprising events, entry to states, and exit from states.

3. The method according to claim 2, further comprising support of internal state transitions and external state transitions.

4. The method according to claim 2, wherein the hierarchical state machine further comprises a history mechanism.

5. The method according to claim 2, further comprising calculating class hierarchies to determine if behavior defined in the parent class is executed.

6. The method according to claim 5, wherein the behavior defined to both parent and subclass comprises entry and exit behavior.

7. A computer program product in a computer readable medium for use in a data processing system, for enhancing state patterns in object-oriented programming, the computer program product comprising:
instructions for combining state patterns with hierarchical finite state machines; and
instructions for using inheritance, polymorphism and reflection to create hierarchical state objects and call methods associated with the state objects.

8. The computer program product according to claim 7, wherein the methods called by reflection execute behaviors comprising events, entry to states, and exit from states.

9. The computer program product according to claim 8, further comprising instructions for support of internal state transitions and external state transitions.

10. The computer program product according to claim 8, wherein the hierarchical state machine further comprises a history mechanism.

11. The computer program product according to claim 8, instructions for calculating class hierarchies to determine if behavior defined in the parent class is executed.

12. The computer program product according to claim 11, wherein the behavior defined to both parent and subclass comprises entry and exit behavior.

13. A system for enhancing state patterns in object-oriented programming, comprising:
means for combining state patterns with hierarchical finite state machines; and
means for using inheritance, polymorphism and reflection to create hierarchical state objects and call methods associated with the state objects.

14. The system according to claim 13, wherein the methods called by reflection execute behaviors comprising events, entry to states, and exit from states.

15. The system according to claim 14, further comprising means for describing entry and exit behavior for internal state transitions versus external state transitions.

16. The system according to claim 14, wherein the hierarchical state machine further comprises a history mechanism.

17. The system according to claim 14, further comprising means for calculating class hierarchies to determine if behavior defined in the parent class is executed. 18. The system according to claim 17, wherein the behavior defined to both parent and subclass comprises entry and exit behavior.
